(19) United States
(12) Patent Application Publication
(10) Pub. No.: US 2012/0286572 A1
(43) Pub. Date: Nov. 15, 2012

(54) SELF-SUFFICIENT GENERATOR FOR PRODUCING ELECTRICAL POWER

(76) Inventor: STEVEN B. TRACY, WELLS, ME (US)

(21) Appl. No.: 13/465,206

(22) Filed: May 7, 2012

Related U.S. Application Data
(60) Provisional application No. 61/484,302, filed on May 10, 2011.

(51) Int. Cl. H02J 3/32; H02K 47/04; H02K 53/00

(52) U.S. Cl. 307/19; 310/113; 74/DIG. 9

(57) ABSTRACT

A self-sufficient generator system includes one or more battery banks recharged by alternators driven by a motor. A main battery bank provides power to a load while other battery banks power the motor.

### CROSS-REFERENCE TO RELATED APPLICATION

This application claims benefit under 35 U.S.C. §119(e) of U.S. Provisional Application No. 61/484,302 filed May 10, 2011, which is hereby incorporated by reference herein in its entirety.

### BACKGROUND OF THE INVENTION

The present invention generally relates to power generator systems, and more particularly, to a self-sufficient generator for producing electrical power.

As fuel consumption demands continue to increase, the need for systems that can produce energy more efficiently becomes ever more significant. Typical power generators convert one fuel source into electrical power and thus rely on resupplying the fuel source periodically to continue to produce electricity.

As can be seen, there is a need for a generator that can produce power more efficiently and with minimal resupplying of a fuel source or an external power source.

### SUMMARY OF THE INVENTION

In one aspect of the present invention, a self-sufficient generator system comprises a first bank of batteries; a second bank of batteries; a motor in electrical communication with the first and second bank of batteries; a first alternator connected between the first bank of batteries and the motor; a second alternator connected between the second bank of batteries and the motor; a third alternator disposed to be driven by the motor; and a main bank of batteries connected between the third alternator and a load.

In another aspect of the present invention, a self-sufficient generator system comprises a motor; a first battery bank supplying power to the motor; a clutch assembly coupled to the motor; a first alternator connected to and turned by the clutch assembly, wherein the first battery bank is recharged by the first alternator; a main battery bank configured to provide power to a load; and a second alternator connected to and turned by the clutch assembly, wherein the main battery bank is charged by the second alternator.

These and other features, aspects and advantages of the present invention will become better understood with reference to the following drawings, description and claims.

### BRIEF DESCRIPTION OF THE DRAWINGS

FIG. 1 illustrates a block diagram of a self-sufficient generator for producing electrical power according to an exemplary embodiment of the present invention;

FIG. 2 illustrates a perspective front view of the self-sufficient generator system for producing electrical power of FIG. 1;

FIG. 3 illustrates an exploded view of the self-sufficient generator system of FIG. 2;

FIG. 4 illustrates a back side view of the self-sufficient generator system of FIG. 2; and

FIG. 5 illustrates an end view of the self-sufficient generator system of FIG. 2.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention generally provides a self-sufficient generator for producing electrical power independent of an external power supply or a fuel-run generating system.

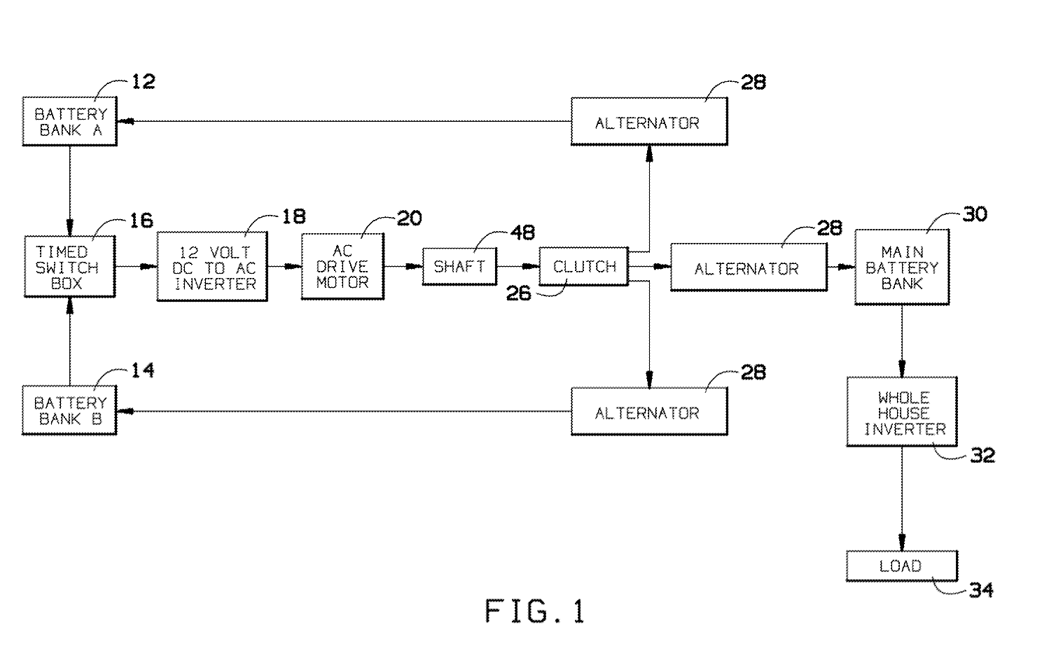

Referring to FIG. 1, a self-sufficient generator system 10 for producing electrical power is shown according to an exemplary embodiment of the present invention. The self-sufficient generator system 10 may sometimes be referred to as the generator system 10. The self-sufficient generator system 10 may include a first drive battery bank 12, a second drive battery bank 14 connected to the first battery bank 12, and a timed switchbox 16 connected on one side of the first battery bank 12 and on the other side to the second battery bank 14. The timed switchbox 16 may control which of the battery banks (12 or 14) may be used to provide power to a motor 20 in electrical communication with the battery banks (12 and 14). An inverter 18 may be operatively connected to the timed switchbox 16. The motor 20 may connected to the inverter 18. A shaft 48 and a clutch 26 may be coupled to the motor 20. In an exemplary embodiment, at least one alternator 28 may be operatively connected to the motor 20 and a plurality of batteries. For example, a first alternator 28 may be coupled between the clutch 26 and a main bank of batteries 30 so that the third alternator 28 is driven by the motor 20. Another alternator 28 may be connected between the clutch 26 and the first bank of batteries 12. A third alternator 28 may be connected between the clutch 26 and the second bank of batteries 14. A house inverter 32 may be connected to the main bank of batteries 30 and a load 34.

The first bank of batteries 12 and the second bank of batteries 14 may include any commercially available batteries. The amperage and size of the first bank of batteries 12 and the second bank of batteries 14 may depend on the amount of energy required to operate the motor 20. In some embodiments, the first bank of batteries 12 and the second bank of batteries 14 may be standard 12 volt deep cycle batteries. The first bank of batteries 12 and the second bank of batteries 14 may be connected in parallel. The first bank of batteries 12 and the second bank of batteries 14 may work independently from each other. The first bank of batteries 12 and the second bank of batteries 14 may provide the motor 20 with a constant supply of energy. In an exemplary embodiment, the first bank of batteries 12 and the second bank of batteries 14 may be constantly charged where one battery bank gets charged while the other provides the power to the motor 20. Thus, while though both battery banks (12, 14) may be charged continuously by independent alternators, one bank may be free from load which would assist in limiting the cycling of the batteries in the banks (12,14), thereby extending the life of those batteries.

In some embodiments, the generator 10 may only include one bank of batteries (12 or 14). In this embodiment, the battery bank (12 or 14) may provide all of the amperage required by the motor 20. Embodiments including only one drive bank (either 12 or 14), can be employed when enough inverted electricity can be supplied by the drive battery bank (12 or 14) to maintain the energy requirements of the motor 20. The lone battery bank (12 or 14) may be inverted producing the AC power for the motor 20 and all subsequent loading while it is able to maintain a positive charge in the battery bank (12 or 14).

The inverter 18 may receive the power generated by the first bank of batteries 12 and the second bank of batteries 14 and supply the power to the motor 20. The inverter 18 may be a DC to AC electrical inverter.

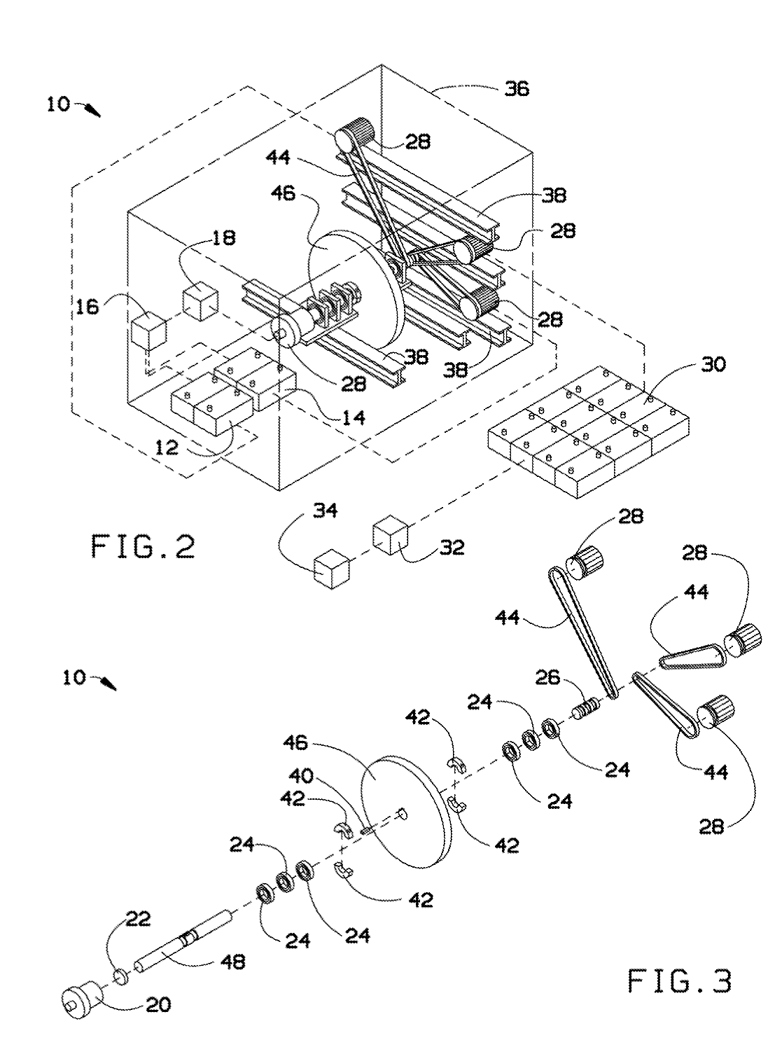

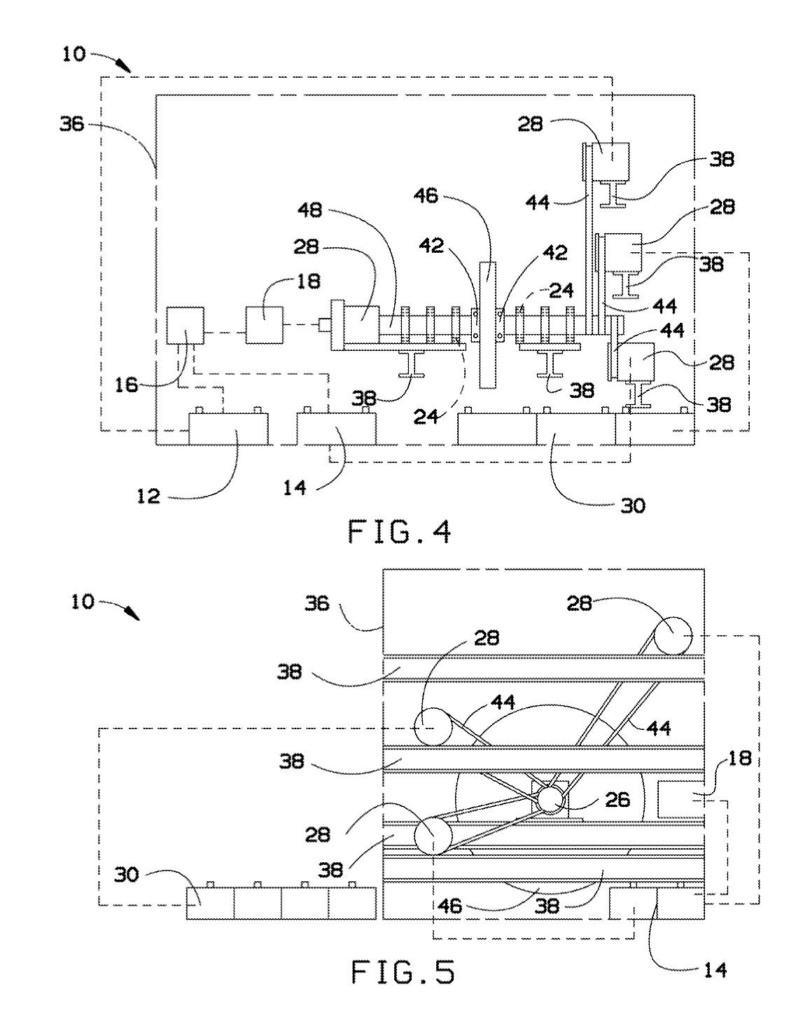

Referring now to FIGS. 2-5, the self-sufficient generator system 10 for producing electrical power is shown according to an exemplary embodiment of the present invention. The motor 20 may be connected to a shaft 48 by means of a coupling 22. The shaft 48 may be supported by bearings 24 which may be capable of supporting the weight and movement of the shaft 48 and its load. The shaft 48 may turn a flywheel 46. The size and weight of the flywheel 46 may depend on the size of the motor 20. In some embodiments, the flywheel 46 may have a diameter of approximately 40 inches. In some embodiments, the flywheel 46 may weigh at least 500 lbs. The shaft 48 may be attached to the flywheel 46 by means of one or more fixed collars 42 positioned on either side of the flywheel 46. The collars 42 may be attached directly to the shaft 48 or to a keyway 40 machined into both the shaft 48 and the flywheel 46. In order to balance the flywheel 46, a second fixed collar 42 supported by bearings 24 may be placed on the other side of the flywheel 46. The opposite side of the shaft 48 may be connected to a clutch assembly 26, which, by means of at least one drive belt 44, turn one or more of the alternators 28.

An angular momentum of the flywheel 46 may turn the alternators 28 to keep the main bank of batteries 30 charged in order for the generator 10 to operate. The mass of the flywheel 46 multiplied by the speed at which it is turning provides the net force required to turn the alternators 28. The number of alternators 28 may depend on the amount of power required by the user. The alternators 28 may be supported in the generator system 10 by a frame 38. As described above, one of the alternators 28 may be connected to the first bank of batteries 12. Another of the alternators 28 may be connected to the second bank of batteries 14. Another of the alternators 28 may be connected to the main battery bank 30. thus, each alternator 28 may be continually charging the bank of batteries (12, 14, or 30) to which they are connected. While only one alternator 28 is connected directly to the main bank of batteries 30, it will be understood that a plurality of alternators 28 may be connected to charge the main bank 30 with enough power as needed.

The use of alternators 28 to charge the main battery bank 30 allows the power load 34 to be drawn from the main battery bank 30 itself and not directly from the alternators 28. On the generator system 10, unlike a system that uses standard generators, there is no draw down of the charging units, allowing a smooth, continuous, and uninterrupted charging to take place.

The main battery bank 30 may be the source of where the user may get the required power for load 34 from a house inverter 32. The house inverter 32 may be a DC to AC inverter.

The generator system 10 may be encased in a case 36. The case 36 may be made of steel, rubber, wood, or plastic. The size of the generator system 10 may depend on the amount of power required by the user.

In an exemplary application, the generator system 10 may be connected to an existing electrical panel by a licensed electrician. The generator system 10 may be used to recharge electric vehicles or to produce hydrogen to create a fuel source for clean transportation reducing the need for gasoline. In one aspect, the generator system 10 may create its own energy to run by recharging the battery banks 12,14 during times of decreased load, in addition to excess energy, which may then be used by the consumer for other load needs.

It should be understood, of course, that the foregoing relates to exemplary embodiments of the invention and that modifications may be made without departing from the spirit and scope of the invention as set forth in the following claims.

What is claimed is:

1. A self-sufficient generator system, comprising:
a first bank of batteries;
a second bank of batteries;
a motor in electrical communication with the first and second bank of batteries;
a first alternator connected between the first bank of batteries and the motor;
a second alternator connected between the second bank of batteries and the motor;
a third alternator disposed to be driven by the motor; and
a main bank of batteries connected between the third alternator and a load.

2. The self-sufficient generator system of claim 1, wherein the load draws power from the main bank of batteries.

3. The self-sufficient generator system of claim 1 further comprising a timed switchbox between the first and second banks of batteries configured to control power to the motor.

4. The self-sufficient generator system of claim 3 further comprising an inverter operatively connected to the timed switchbox.

5. The self-sufficient generator system of claim 1 further comprising a clutch assembly connected to each of the first, second, and third alternators.

6. A self-sufficient generator system, comprising:
a motor;
a first battery bank supplying power to the motor;
a clutch assembly coupled to the motor;
a first alternator connected to and turned by the clutch assembly, wherein the first battery bank is recharged by the first alternator;
a main battery bank configured to provide power to a load; and
a second alternator connected to and turned by the clutch assembly, wherein the main battery bank is charged by the second alternator.

7. The self-sufficient generator system of claim 6 wherein the load draws power from the main battery bank and not the first battery bank.

8. The self-sufficient generator system of claim 6 further comprising an inverter operatively connected between the main battery bank and the load.
